(19) United States
(12) Patent Application Publication
(10) Pub. No.: US 2017/0168853 A1
(43) Pub. Date: Jun. 15, 2017

(54) DYNAMIC PREDICTIVE WAKE-UP TECHNIQUES

(71) Applicant: QUALCOMM Incorporated, San Diego, CA (US)

(72) Inventors: Sankaran Nampoothiri, Bangalore (IN); Narasimhan Venkata Agaram, Hyderabad (IN); Nir Gerber, Haifa (IL); Subodh Singh, Bangalore (IN)

(21) Appl. No.: 15/367,567

(22) Filed: Dec. 2, 2016

(30) Foreign Application Priority Data
Dec. 14, 2015 (IN) 6690/CHE/2015

(51) Int. Cl. G06F 9/44; G06F 1/32; G06F 13/24; G06F 3/06

(52) U.S. Cl. CPC G06F 9/4418; G06F 3/0659; G06F 1/3287; G06F 3/061; G06F 3/0673; G06F 13/24

(57) ABSTRACT

Dynamic predictive wake-up techniques are disclosed. A central processing unit (CPU) may initiate an input/output (I/O) transfer. The CPU may ascertain if a predicted time for the transfer exceeds an amount of time required to enter and exit a low-power mode and enter the low-power mode after the transfer is initiated. An I/O controller may calculate how long the transfer will take and compare that calculation to a known exit latency associated with the CPU. The calculated value is decremented by the amount of the known exit latency and the I/O controller may generate an early wake command at the decremented value. The CPU receives the early wake command and wakes such that the CPU is awake and ready to process data at conclusion of the transfer.

### PRIORITY APPLICATION

The present application claims priority to Indian Patent Application Serial No. 6690/CHE/2015, filed Dec. 14, 2015 and entitled “DYNAMIC PREDICTIVE WAKE-UP TECHNIQUES,” which is incorporated herein by reference in its entirety.

### BACKGROUND

I. Field of the Disclosure

The technology of the disclosure relates generally to sleep management for integrated circuits.

II. Background

The number and variety of mobile computing devices has increased dramatically over the past two decades. Part of the reason for the expansion in the number of devices is the increased versatility of such devices. In particular, the number and types of functions that are enabled has steadily increased so that what were initially simple mobile phones have evolved into multi-function multimedia devices. The increase in versatility is due, in part, to better battery life. However, in a moderately ironic twist, battery life is negatively impacted as people use the devices for more activities that have been enabled by the increased functionality.

One way that manufacturers have attempted to extend battery life is by putting various components within a mobile computing device into a sleep or low-power mode. Various types of sleep modes exist, and different elements within the mobile computing device may use different sleep modes depending on system parameters such as entry and exit latency, energy overhead, and the like. One particular sleep mode that is used by manufacturers is to place a central processing unit (CPU) in a low-power state after requesting a memory access or initiating a multimedia coding transfer. When the memory access or multimedia coding transfer is complete, the CPU wakes and issues the next instruction and/or begins processing the data from the transfer.

Delays may accrue when the CPU begins to wake after completion of the memory access or multimedia coding transfer. Various techniques such as low-power mode disabling have been implemented to try to make sure the CPU is ready substantially concurrently with the end of the memory access or multimedia coding transfer so as to avoid accrual of delays. However, these methods are not optimal because disabling the low-power mode reduces the power savings and decreases battery life.

### SUMMARY OF THE DISCLOSURE

Aspects disclosed in the detailed description include dynamic predictive wake-up techniques. In an exemplary aspect, a central processing unit (CPU) may initiate a memory access or other input/output (I/O) transfer such as a multimedia encoding transfer. The CPU may ascertain if a predicted time for the transfer exceeds an amount of time required to enter and exit a low-power mode. If the predicted time is sufficiently large to justify entering the low-power mode, then the CPU enters the low-power mode after the transfer is initiated. An I/O controller may generate the predicted time that the CPU uses to determine whether to enter the low-power mode. The I/O controller may further use the predicted time for the transfer to predict an early wake-up. Specifically, the I/O controller may calculate how long the transfer will take and compare that calculation to a known exit latency associated with the CPU. The calculated value is decremented by the amount of the known exit latency and the I/O controller may generate an early wake command at the decremented value. The CPU receives the early wake command and wakes such that the CPU is awake and ready to process data at conclusion of the transfer. While it is possible to do a static calculation, it should be appreciated that encoding and data transfer speeds may vary during the course of the transfer. Accordingly, the I/O controller may dynamically or iteratively recalculate the time at which the early wake command should be sent. By waking the CPU “just in time” to begin the next transfer, maximal power savings are achieved relative to minimal latency. Thus, performance of the device is improved. While aspects of the present disclosure are particularly well-suited for use with a CPU, other logic elements that initiate I/O transfers and have sleep cycles, such as a digital signal processor (DSP), a graphics processing unit (GPU), a microcontroller, base band processor (BBP) or other processor or sub-system which uses the data of an input/output or is needed to control the next processing, may also benefit from the concepts of the present disclosure.

In this regard in one aspect, a method for promoting efficient waking of a logic element is disclosed. The method includes initiating, at a logic element, an I/O transfer. The method also includes determining a first transfer rate associated with the I/O transfer. The method also includes calculating a first time needed to complete the I/O transfer based on the first transfer rate. The method also includes deducting from the first time an exit latency associated with the logic element to determine an early wake time. The method also includes determining if the first transfer rate has changed. The method also includes updating the early wake time. The method also includes sending a wake command to the logic element at the early wake time.

In another aspect, a computing device is disclosed. The computing device includes an I/O element. The computing device also includes a logic element configured to initiate an I/O transfer with the I/O element. The computing device also includes an I/O controller. The I/O controller is configured to manage the I/O transfer while the logic element enters a low-power mode. The I/O controller is also configured to determine a first transfer rate associated with the I/O transfer. The I/O controller is also configured to calculate a first time needed to complete the I/O transfer based on the first transfer rate. The I/O controller is also configured to deduct from the first time an exit latency associated with the logic element to determine an early wake time. The I/O controller is also configured to determine if the first transfer rate has changed. The I/O controller is also configured to update the early wake time. The I/O controller is also configured to send a wake command to the logic element at the early wake time.

In another aspect, an I/O controller is disclosed. The I/O controller includes a bus interface configured to couple to a bus. The I/O controller also includes circuitry. The circuitry is configured to manage an I/O transfer while an initiating logic element enters a low-power mode. The circuitry is also configured to determine a first transfer rate associated with the I/O transfer. The circuitry is also configured to calculate a first time needed to complete the I/O transfer based on the first transfer rate. The circuitry is also configured to deduct from the first time an exit latency associated with the initiating logic element to determine an early wake time. The circuitry is also configured to determine if the first transfer rate has changed. The circuitry is also configured to update the early wake time. The circuitry is also configured to send a wake command to the initiating logic element at the early wake time.

In another aspect, a method for promoting efficient waking of a logic element is disclosed. The method includes initiating, at a logic element, an I/O transfer. The method also includes determining a first transfer rate associated with the I/O transfer. The method also includes calculating a time completion value representing a time needed to complete the I/O transfer based on the first transfer rate. The method also includes calculating a current transfer rate. The method also includes updating the time completion value to a current time completion value based on the current transfer rate. The method also includes comparing the current time completion value to a known exit latency. The method also includes sending a wake command to the logic element when the current time completion value is less than or equal to the known exit latency.

In another aspect, a method for controlling entry of a logic element into a low-power mode is disclosed. The method includes calculating, with an I/O controller, a first time needed to complete an I/O transfer initiated by a logic element. The method also includes comparing the first time to a sum of an exit latency associated with the logic element and an entry latency associated with the logic element. The method also includes precluding entry into a low-power mode if the first time is less than the sum.

### BRIEF DESCRIPTION OF THE FIGURES

FIG. 1 is a block diagram of an exemplary computing device;

FIG. 2 is a time versus power diagram illustrating latency issues with conventional computing devices;

FIG. 3 is a flowchart illustrating an exemplary process for programming an input/output (I/O) controller within the computing device of FIG. 1;

FIG. 4 is a flowchart illustrating an exemplary process for dynamically predicting early wake-up for the central processing unit (CPU) of the computing device of FIG. 1;

FIG. 5 is a flowchart illustrating an alternate exemplary process for dynamically predicting early wake-up for the CPU; and

FIG. 6 is a time versus power diagram illustrating how aspects of the present disclosure solve the latency issues illustrated in FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include dynamic predictive wake-up techniques. In an exemplary aspect, a central processing unit (CPU) may initiate a memory access or other input/output (I/O) transfer such as a multimedia encoding transfer. The CPU may ascertain if a predicted time for the transfer exceeds an amount of time required to enter and exit a low-power mode. If the predicted time is sufficiently large to justify entering the low-power mode, then the CPU enters the low-power mode after the transfer is initiated. An I/O controller may generate the predicted time that the CPU uses to determine whether to enter the low-power mode. The I/O controller may further use the predicted time for the transfer to predict an early wake-up. Specifically, the I/O controller may calculate how long the transfer will take and compare that calculation to a known exit latency associated with the CPU. The calculated value is decremented by the amount of the known exit latency and the I/O controller may generate an early wake command at the decremented value. The CPU receives the early wake command and wakes such that the CPU is awake and ready to process data at conclusion of the transfer. While it is possible to do a static calculation, it should be appreciated that encoding and data transfer speeds may vary during the course of the transfer. Accordingly, the I/O controller may dynamically or iteratively recalculate the time at which the early wake command should be sent. By waking the CPU “just in time” to begin the next transfer, maximal power savings are achieved relative to minimal latency. Thus, performance of the device is improved. While aspects of the present disclosure are particularly well-suited for use with a CPU, other logic elements that initiate I/O transfers and have sleep cycles, such as a digital signal processor (DSP), a graphics processing unit (GPU), a microcontroller, base band processor (BBP) or other processor or sub-system which uses the data of an input/output or is needed to control the next processing, may also benefit from the concepts of the present disclosure.

While the present disclosure uses the word “transfer” to describe the I/O action, it should be appreciated that some such transfers may also be described as transactions without departing from the scope of the present disclosure. For example, an encoding/decoding transfer may also be described as an encoding or decoding transaction. Thus, as used herein, a transaction is a subset of the transfers discussed herein.

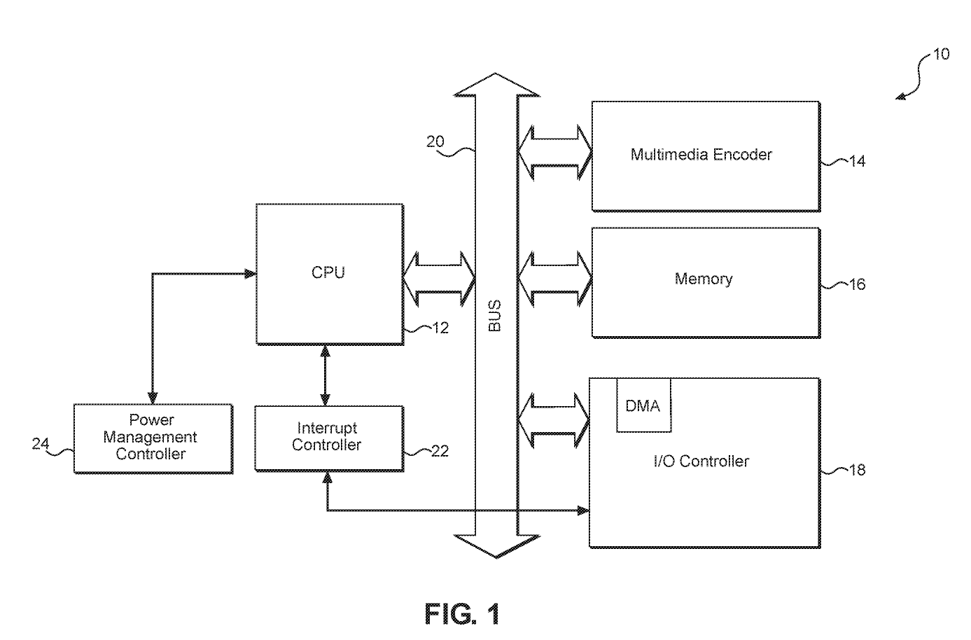

Exemplary aspects of the present disclosure deal with controlling whether a logic element, such as a CPU, enters a low-power mode and using a prediction related to a pending I/O transfer to determine when to wake the logic element so as to reduce latency associated with the transfer. In this regard, FIG. 1 is a block diagram of a computing device 10. While a mobile computing device is most likely to benefit from the reduced latency power-saving activities described herein, it should be appreciated that other forms of power-constrained computing devices or computing devices such as a desktop computer or server may also benefit from the reduced latency opportunities described herein. The computing device 10 includes a CPU 12 coupled to a multimedia encoder 14, memory 16, and an I/O controller 18 through a bus 20. It should be appreciated that each of the CPU 12, the multimedia encoder 14, the memory 16, and the I/O controller 18 include respective interfaces (not shown explicitly) configured to couple to the bus 20. The I/O controller 18 may include a direct memory access (DMA) module that may be used to assist with memory access transfers. Additionally, an interrupt controller 22 and a power management controller 24 are communicatively coupled to the CPU 12. The interrupt controller 22 is communicatively coupled to the I/O controller 18. Communication between the I/O controller 18 and the interrupt controller 22 may be through the bus 20 or a direct connection as needed or desired. While not explicitly shown, it should be appreciated that the CPU 12, the multimedia encoder 14, the memory 16, the I/O controller 18, the interrupt controller 22, and the power management controller 24 may include circuitry configured to perform the functions outlined herein. Further note that while the present disclosure does describe the CPU 12, multimedia encoder 14, and the like, other I/O controllers, other logic elements and/or other computing modules may be used in conjunction with the techniques described herein.

In normal operation, the CPU 12 may initiate an I/O transfer such as a memory access (e.g., read or write) to the memory 16 or utilization of the multimedia encoder 14 to encode data. As such, the memory 16 and the multimedia encoder 14 are sometimes referred to herein as I/O elements. It should be appreciated that other I/O controllers and/or other I/O elements (not illustrated) may also be present, and the term I/O element is not limited to memories and multimedia encoders. While the CPU 12 waits for the transfer to conclude, the CPU 12 may be idle. In such instances, it may be appropriate to put the CPU 12 into a low-power mode. Exemplary aspects of the present disclosure initially determine if use of a low-power mode is appropriate, and if a low-power mode is used, exemplary aspects of the present disclosure further allow the CPU 12 to return to normal operation immediately prior to conclusion of the I/O transfer. Such timely return to normal operation reduces latency associated with prior solutions.

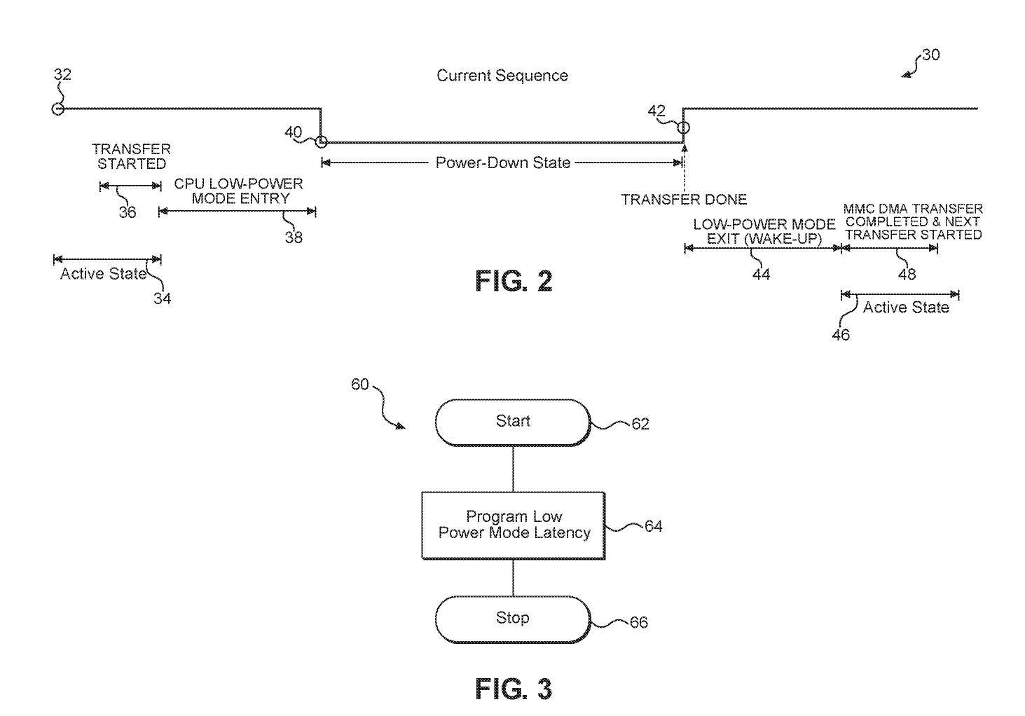

In this regard, FIG. 2 illustrates a time versus power diagram 30 that highlights the latency inherent in conventional solutions. In particular, in conventional solutions a CPU (not shown) begins in a normal power state (illustrated generally at 32) and is in an active state 34. At some point during the active state 34 a data transfer is initiated (illustrated generally at 36). Once the data transfer is initiated, the CPU leaves the active state 34 and begins low-power entry with associated entry latency (illustrated generally at 38) until the CPU is in a power-down state (illustrated generally at 40). The CPU remains in the power-down state until the data transfer is complete (illustrated generally at 42). When the data transfer is complete, the CPU begins to exit the low-power mode with associated exit latency (illustrated generally at 44). Only after the wake-up is completed can the CPU enter active state 46 and begin the next data transfer (illustrated generally at 48). All of the time during wake-up is time during which no processing occurs and introduces latency into operations of the computing device.

In contrast, exemplary aspects of the present disclosure initially determine whether latency will be increased by entering the low-power mode, and if the low-power mode is used, exemplary aspects eliminate the delay waiting for the wake-up to finish. In particular, exemplary aspects of the present disclosure predict when a data transfer is likely to be completed and compare this time prediction to a sum of the entry latency and the exit latency. If the time prediction is shorter than the sum, then entering a low-power mode is actually inefficient because it adds latency to the system and the potential power savings are not realized since the logic element begins exiting the low-power mode as soon as the low-power mode has been achieved. Exemplary aspects further decrement the predicted time by a wake-up latency for the CPU 12 of FIG. 1. The decremented time is used to send a preemptive wake signal to the CPU 12 such that the CPU 12 finishes waking substantially concurrently with the completion of the data transfer such that the CPU 12 may resume active operations without delay.

In this regard, FIGS. 3-5 illustrate exemplary processes through which such latency is reduced or eliminated from the computing device 10 of FIG. 1. Specifically, FIG. 3 illustrates a process 60 for providing entry and exit latencies of the CPU 12 to the I/O controller 18. Process 60 starts (block 62). The CPU 12 knows a priori its own entry and exit latencies for each low-power mode. The CPU 12 programs the I/O controller 18 with each latency for each low-power mode (block 64). The programming may store values in registers (not shown) within the I/O controller 18. The programming may be performed by software or by directly writing to the registers within the I/O controller 18. Additionally, the CPU 12 may provide information about the current CPU power state (e.g., active or low power). The process 60 then stops (block 66).

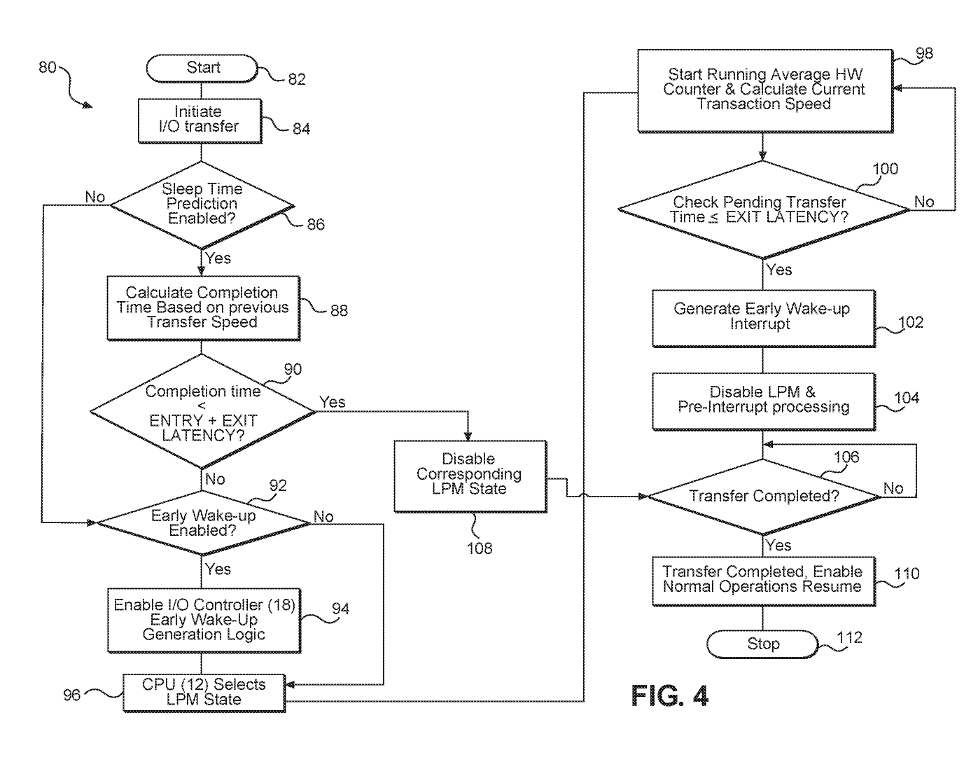

FIG. 4 illustrates a process 80 for dynamically predicting early wake-up for the CPU 12 of FIG. 1. The process 80 starts (block 82) with the CPU 12 initiating the I/O transfer (block 84). For example, the CPU 12 may initiate a memory access (read or write) from the memory 16 or request that the multimedia encoder 14 encode some multimedia data. Such initiation may be made by software operating on the CPU 12 or may be a function of hardware within the CPU 12. The I/O controller 18 begins the I/O transfer (e.g., transferring data to or from the memory 16). The CPU 12 determines if sleep time prediction is enabled (block 86). Sleep time prediction allows the CPU 12 to determine if the CPU 12 should go to sleep or not. If the sleep time prediction is enabled, the I/O controller 18 calculates a completion time based on a previous transfer speed (block 88). Thus, a historical or previous transfer speed is a first transfer rate that may be used to calculate a first time needed to complete the I/O transfer.

With continued reference to FIG. 4, the CPU 12 determines if the calculated completion time is less than a sum of the entry latency and the exit latency for a given low-power mode (LPM) (block 90). Checking to see if the predicted completion time is less than the sum of the latencies effectively insures that the CPU 12 will have time to go all the way into the low-power mode and exit the low-power mode before the end of the transfer. If the answer to block 90 is no, the completion time is greater than the entry and exit latencies, then the CPU 12 determines if early wake-up is enabled (block 92). Note that if the answer to block 86 is no, the sleep time prediction is disabled, the process 80 skips blocks 88 and 90 and resumes at block 92. If the answer to block 92 is yes, then the CPU 12 enables the I/O controller 18 early wake-up generation logic (block 94) and the CPU 12 selects a LPM state (block 96). Note that if the answer to block 92 is no, the early wake-up is disabled, the process 80 jumps to block 96 and the CPU 12 selects a LPM state.

With continued reference to FIG. 4, after the CPU 12 selects the LPM state, the I/O controller 18 starts a running average using a hardware (HW) counter and determines if the transfer rate has changed by calculating a current transfer speed and comparing the current transfer speed to the historical or previous transfer speed (block 98). The I/O controller 18 checks pending transfer time to the exit latency (block 100). If the pending transfer time is greater than the exit latency, the process 80 returns to block 100 and updates the current transfer speed. If the pending transfer time is less than or equal to the exit latency, the I/O controller 18 generates an early wake-up interrupt (block 102). The early wake-up interrupt is passed to the interrupt controller 22, which forwards the early wake-up interrupt to the power management controller 24.

With continued reference to FIG. 4, the power management controller 24 begins to wake the CPU 12 by disabling the LPM and performing any other pre-interrupt processing (block 104). Exemplary pre-interrupt processing may depend on I/O data and software, but may include waking up one or more threads, pre-processing metadata, increasing a frequency of the CPU 12 based on processing needs, or the like. The I/O controller 18 determines if the I/O transfer is complete (block 106). Note that if the answer to block 90 is yes, the completion time was less than the sum of the entry and exit latencies, the I/O controller 18 disables the corresponding LPM state (block 108) and prevents the CPU 12 from entering the LPM before skipping to block 106. By disabling the LPM state, the latency associated with cycling through a LPM state without generating any power savings from spending any time in the LPM state is avoided. Once the I/O transfer is complete, the I/O controller 18 may calculate a new transfer speed based on the most recent transfer and stores the transfer speed for the next time the process 80 is invoked (i.e., it is used at block 88). Additionally, once the I/O transfer is complete, normal operations at the CPU 12 resume (block 110) and the process 80 stops (block 112).

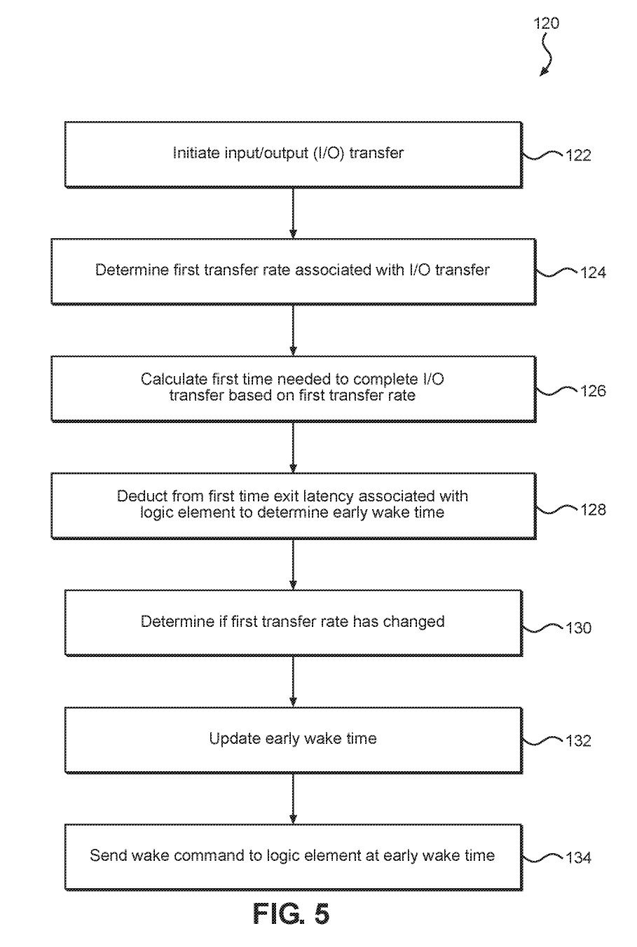

Instead of iteratively comparing the pending transfer time to the exit latency (e.g., block 100), exemplary aspects of the present disclosure may calculate a wake-up time by decrementing a calculated transfer time. In this regard, FIG. 5 illustrates a process 120 for promoting efficient wake-up of a logic element such as the CPU 12 of FIG. 1. The process 120 begins with initiating an I/O transfer (block 122), such as when the CPU 12 initiates a memory access or requests multimedia encoding. The I/O controller 18 determines a first transfer rate associated with the I/O transfer (block 124). The I/O controller 18 then calculates a first time needed to complete the I/O transfer based on the first transfer rate (block 126). The I/O controller 18 then deducts from the first time an exit latency associated with the logic element to determine an early wake time (block 128). The I/O controller 18 determines if the first transfer rate has changed (block 130). If the first transfer rate has changed, the I/O controller 18 updates the early wake time (block 132) and sends a wake command to the logic element, such as the CPU 12, at the early wake time (block 134).

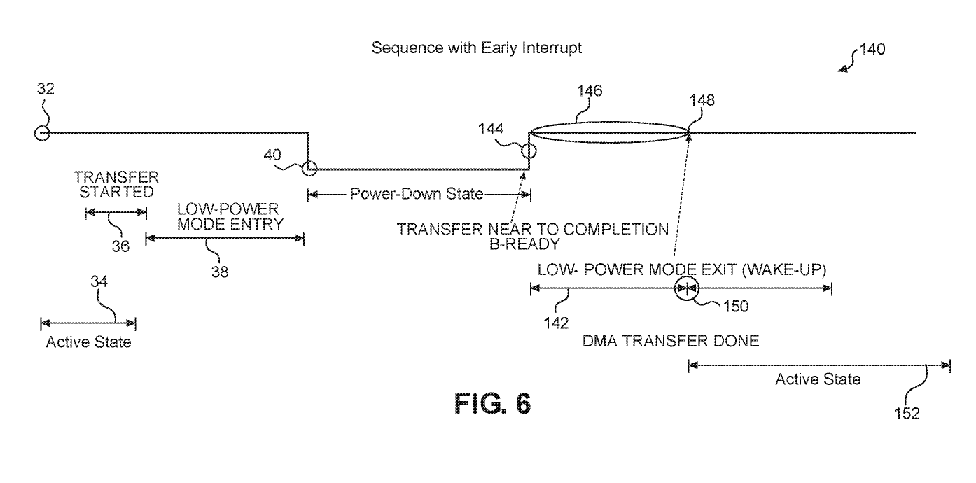

FIG. 6 illustrates a time versus power diagram 140 that highlights elimination or reduction in latency delays achieved by exemplary aspects of the present disclosure. As with the time versus power diagram 30 of FIG. 2, the CPU 12 of FIG. 1 begins in a normal power state (illustrated generally at 32) and is in the active state 34. At some point during the active state 34 a data transfer is initiated (illustrated generally at 36). Once the data transfer is initiated, the CPU 12 leaves the active state 34 and begins low-power mode entry (illustrated generally at 38) until the CPU 12 is in a power-down state (illustrated generally at 40). Unlike the time versus power diagram 30, the I/O controller 18 does not wait until the end of the data transfer to wake the CPU 12. In particular, by implementing exemplary aspects of the present disclosure, the I/O controller 18 effectively predicts completion of the data transfer and while the data transfer is nearing completion, initiates early wake-up, indicated generally at 142), such that the CPU 12 leaves the low-power mode (generally at 144), taking the exit latency (generally at 146) to become ready to resume active operations. The end of the exit latency (148) is substantially contemporaneous with the end of the data transfer (150) and the CPU 12 is already in active state 152 so that the next transfer (or other operation) may be stared (154).

The dynamic wake-up techniques according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a DSP, an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for promoting efficient waking of a logic element, the method comprising:
initiating, at a logic element, an input/output (I/O) transfer;
determining a first transfer rate associated with the I/O transfer;
calculating a first time needed to complete the I/O transfer based on the first transfer rate;
deducting from the first time an exit latency associated with the logic element to determine an early wake time;
determining if the first transfer rate has changed;
updating the early wake time; and
sending a wake command to the logic element at the early wake time.

2. The method of claim 1, wherein initiating at the logic element comprises initiating at a central processing unit (CPU).

3. The method of claim 1, wherein calculating the first time comprises calculating at an I/O controller.

4. The method of claim 3, further comprising providing the exit latency associated with the logic element from the logic element to the I/O controller.

5. The method of claim 1, wherein determining the first transfer rate comprises using a previous transfer speed.

6. The method of claim 1, wherein determining if the first transfer rate has changed comprises using a hardware counter to calculate a current transfer speed.

7. The method of claim 1, wherein sending the wake command comprises sending an interrupt command to an interrupt controller.

8. The method of claim 1, further comprising sending an I/O completion interrupt at completion of the I/O transfer.

9. The method of claim 1, wherein initiating, at the logic element, the I/O transfer comprises initiating a data transfer to a memory element or a multimedia encoding transfer at a multimedia encoder.

10. The method of claim 1, further comprising:
comparing the first time to a sum of the exit latency and an entry latency; and
precluding entry into a low power mode if the first time is less than the sum.

11. A computing device comprising:
an input/output (I/O) element;
a logic element configured to initiate an I/O transfer with the I/O element; and
an I/O controller configured to:
manage the I/O transfer while the logic element enters a low-power mode;
determine a first transfer rate associated with the I/O transfer;
calculate a first time needed to complete the I/O transfer based on the first transfer rate;
deduct from the first time an exit latency associated with the logic element to determine an early wake time;
determine if the first transfer rate has changed;
update the early wake time; and
send a wake command to the logic element at the early wake time.

12. The computing device of claim 11, wherein the I/O element comprises a memory element.

13. The computing device of claim 11, wherein the I/O element comprises a multimedia encoder.

14. The computing device of claim 11, wherein the logic element comprises a central processing unit (CPU).

15. The computing device of claim 11, further comprising a bus coupled to the I/O element, the I/O controller, and the logic element.

16. The computing device of claim 11, further comprising an interrupt controller configured to pass the wake command from the I/O controller to the logic element.

17. The computing device of claim 11, further comprising a power management controller configured to wake the logic element and place the logic element in the low-power mode.

18. The computing device of claim 11, wherein the logic element is further configured to:
compare the first time to a sum of the exit latency and an entry latency; and
preclude entry into the low-power mode if the first time is less than the sum.

19. An input/output (I/O) controller comprising:
a bus interface configured to couple to a bus; and
circuitry configured to:
manage an I/O transfer while an initiating logic element enters a low-power mode;
determine a first transfer rate associated with the I/O transfer;
calculate a first time needed to complete the I/O transfer based on the first transfer rate;
deduct from the first time an exit latency associated with the initiating logic element to determine an early wake time;
determine if the first transfer rate has changed;
update the early wake time; and
send a wake command to the initiating logic element at the early wake time.

20. The I/O controller of claim 19 wherein the circuitry is further configured to receive the exit latency from the initiating logic element.

21. The I/O controller of claim 19 wherein the circuitry configured to determine the first transfer rate uses a previous transfer speed.

22. The I/O controller of claim 19 wherein the circuitry configured to determine if the first transfer rate has changed comprises a hardware counter configured to calculate a current transfer speed.

23. The I/O controller of claim 19, wherein the circuitry configured to send the wake command comprises circuitry configured to send an interrupt command to an interrupt controller.

24. The I/O controller of claim 19, wherein the circuitry is further configured to send an I/O completion interrupt at completion of the I/O transfer.

25. The I/O controller of claim 19 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

26. A method for promoting efficient waking of a logic element, the method comprising:
initiating, at a logic element, an input/output (I/O) transfer;
determining a first transfer rate associated with the I/O transfer;
calculating a time completion value representing a time needed to complete the I/O transfer based on the first transfer rate;
calculating a current transfer rate;
updating the time completion value to a current time completion value based on the current transfer rate;
comparing the current time completion value to a known exit latency; and
sending a wake command to the logic element when the current time completion value is less than or equal to the known exit latency.
